(19) United States
(12) Patent Application Publication
(10) Pub. No.: US 2026/0237115 A1
(43) Pub. Date: Aug. 13, 2026

(54) IMAGE PROCESSING METHOD, APPARATUS AND DEVICE, AND STORAGE MEDIUM

(71) Applicant: Beijing Zitiao Network Technology Co., Ltd., Haidian District, Beijing (CN)

(72) Inventor: Qianqian WANG, Beijing (CN)

(21) Appl. No.: 19/160,304

(22) PCT Filed: Feb. 19, 2024
(86) PCT No.: PCT/CN2024/077584

§ 371 Date: Aug. 27, 2025

(30) Foreign Application Priority Data
Feb. 28, 2023 (CN) 202310183569.5

(51) Int. Cl. G06T 11/40; G06T 5/77; G06V 10/74; G06V 10/75; G06V 20/00

(52) U.S. Cl. CPC G06T 11/40; G06T 5/77; G06V 10/759; G06V 10/761; G06V 20/00

(57) ABSTRACT

Embodiments of the present disclosure provide an image processing method, apparatus and device, and a storage medium. The method includes: obtaining, in response to an erasing operation on an original image, an image to be filled with an erased area; determining a filling restriction area based on the image to be filled; and determining a filling search area based on the filling restriction area, and filling the erased area to obtain a target image.

### CROSS-REFERENCE TO RELATED APPLICATIONS

The present application is a U.S. National Stage Application under 35 U.S.C. § 371 of International Patent Application No. PCT/CN2024/077584, filed on Feb. 19, 2024, which is based on and claims priority to CN Application No. 202310183569.5, filed on Feb. 28, 2023, the disclosure of both of which are incorporated herein by reference in entirety.

### TECHNICAL FIELD

The present disclosure relates to the technical field of image processing, and in particular, to an image processing method, apparatus and device, and a storage medium.

### BACKGROUND

Currently, application software with a photographing or video recording function typically provides an image editing function for a user to perform personalized editing on an image.

Among function items provided by the application software for image editing, there is a function called an erasing brush. The erasing brush can be used to erase content selected to be erased in an edited image. After erasure, other image content in the image may be used to fill an erased area to form a new image.

However, in the current implementation of image filling, there is a problem that image content presented in the filled image area does not match the style of the surrounding image, resulting in a filling effect that does not meet expectations.

### SUMMARY

According to a first aspect, an embodiment of the present disclosure provides an image processing method. The image processing method includes:
obtaining, in response to an erasing operation on an original image, an image to be filled with an erased area;
determining a filling restriction area based on the image to be filled; and
determining a filling search area based on the filling restriction area, and filling the erased area to obtain a target image.

According to a second aspect, an embodiment of the present disclosure further provides an image processing apparatus. The image processing apparatus includes:
a response module configured to obtain, in response to an erasing operation on an original image, an image to be filled with an erased area;
a restriction determination module configured to determine a filling restriction area based on the image to be filled; and
a filling module configured to determine a filling search area based on the filling restriction area, and fill the erased area to obtain a target image.

According to a third aspect, an embodiment of the present disclosure further provides an electronic device. The electronic device includes:
one or more processors; and
a storage apparatus configured to store one or more programs, where
the one or more programs, when executed by the one or more processors, cause the one or more processors to implement the image processing method according to any one of the embodiments of the present disclosure.

According to a fourth aspect, an embodiment of the present disclosure further provides a storage medium including computer-executable instructions, where the computer-executable instructions, when executed by a computer processor, are used to perform the image processing method according to any one of the embodiments of the present disclosure.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 presents an example diagram of displaying an original image;

FIG. 1a presents an example diagram of performing an erasing operation on an original image;

FIG. 1b presents an example diagram of an effect after performing an erasing operation on an original image and then filling the original image in the related art;

FIG. 1c presents a schematic flowchart of an image processing method according to an embodiment of the present disclosure;

FIG. 1d presents a diagram of displaying an effect of a target image during execution of an image processing method according to an embodiment;

FIG. 2 presents a schematic diagram of a structure of an image processing apparatus according to an embodiment of the present disclosure; and

FIG. 3 presents a schematic diagram of a structure of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

It should be clear that application software with a photographing or video recording function usually provides an image editing function for a user to perform personalized editing on an image. Among function items provided by the application software for image editing, there is a function called an erasing brush. The erasing brush is used to erase an unwanted part of an original image. Specifically, the erasing brush is used to erase content selected to be erased in an edited image. After erasure, other image content in the image may be used to fill an erased area, to form a new image. However, in an existing implementation of image filling, there is a problem that image content presented in a filled image area does not match a style of a surrounding image.

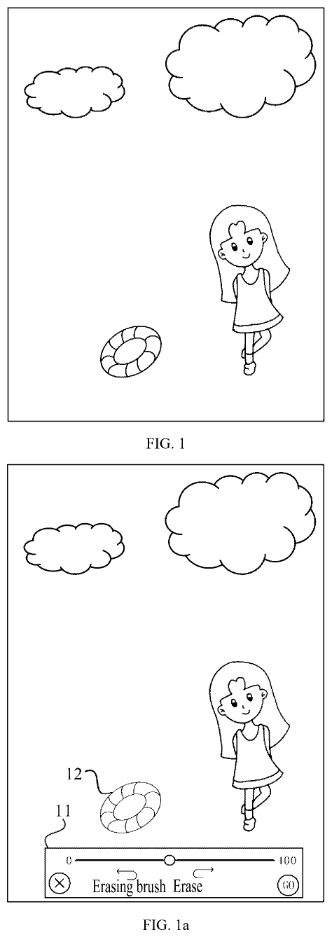

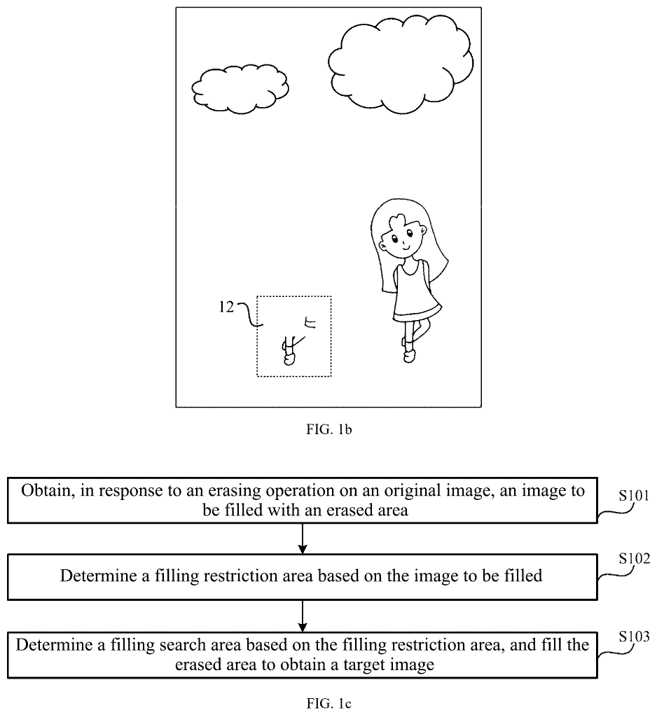

For example, FIG. 1 presents an example diagram of displaying an original image. As shown in FIG. 1, the original image includes a person, a swimming ring, ground, sky, and another scene. A user may erase some areas in the original image by performing an erasing operation. FIG. 1a presents an example diagram of performing an erasing operation on an original image. As shown in FIG. 1a, when the user wants to erase a scene area related to the swimming ring in the original image, the erasing of the scene can be implemented by using an erasing function provided on an erasing editing bar 11. For example, by selecting an object related to the swimming ring and then tapping an erasing brush function button, the scene area related to the swimming ring can be erased. FIG. 1b presents an example diagram of the effect after performing filling following the erasing operation on the original image in the related art. As shown in FIG. 1b, parts of the scene of shoes and clothes of the person are filled into an erased area 12. In the filled image, the filled area includes scenes of the shoes, the clothes, and the like, in addition to the background scene such as the ground. This results in an inharmonious style of the filled image. It can be seen that parts of the person's body appear in the filled area, affecting realism and naturalness of the image formed after the filling.

Based on the above description, an embodiment provides a method for image processing by determining a filling search area based on an area outside a filling restriction area. FIG. 1c presents a schematic flowchart of an image processing method according to an embodiment of the present disclosure. This embodiment of the present disclosure is applicable to a case of filling an erased area during image processing. The method may be performed by an image processing apparatus. The apparatus may be implemented in a form of software and/or hardware, and optionally, may be implemented by an electronic device. The electronic device may be a digital camera, a mobile phone, a tablet computer, or the like.

As shown in FIG. 1c, the image processing method provided in this embodiment of the present disclosure may specifically include: S101-S103.

S101: Obtain, in response to an erasing operation on an original image, an image to be filled with an erased area.

An application scenario of the image processing method provided in this embodiment can be understood as follows: Application software with a photographing or video recording function usually provides an image editing function for a user to perform personalized editing on an image. Among function items provided by the application software for image editing, there is a function that scene erasing is performed on a selected area by using an erasing tool (for example, an erasing option or an erasing brush), and after erasure, an erased area may be filled to form a new image. From a user's perspective, when the user wants to erase a specific scene in the image, an area of the scene may be selected using the erasing tool, and an erasing operation on the selected area is further triggered. This area may be considered as an erased area.

In some embodiments, the original image can be specifically understood as an input image on which an erasing operation and filling processing are to be performed. The original image may be an image stored locally in an electronic device, and an input original image may be obtained using a selection operation of the user. The original image may alternatively be obtained through downloading from the Internet or manual uploading. The original image may alternatively be an original image collected in real time by the electronic device by using an image collection apparatus, and the input original image may be obtained directly from the image collection apparatus. The image collection apparatus may be a module integrated in the electronic device, or may be an external image collection apparatus communicatively connected to the electronic device. A way of obtaining the original image is not specifically limited in this embodiment. When it is detected that an image processing function is enabled, any input original image may be used as an image to be processed, and image processing may be performed on the original image.

It can be understood that, when the user performs the erasing operation on the original image, this execution entity may receive the erasing operation performed by the user. This step may be considered as a response to the received erasing operation. An action object of the erasing operation is the original image, and a purpose of the erasing operation is to: erase some scenes in the original image. In this step, a result obtained after responding to the erasing operation on the original image is determined, and the image to be filled with the erased area is obtained. In this embodiment, an image formed after erasing the some scenes in the original image is the image to be filled, and a corresponding area in the image to be filled after the some scenes are erased is the erased area.

S102: Determine a filling restriction area based on the image to be filled.

Considering that, in the related art, a scene selected for filling when performing filling on the erased area is searched within the entire image of the image to be filled excluding the erased area. This may result in a problem that image content presented in the filled image area does not match the style of the surrounding image due to filling of the erased area with an inharmonious scene. To resolve this problem, in this embodiment, before filling the erased area, scenes that cannot be used for filling is first identified, and an area in which the scenes that cannot be used for filling are located is designated as the filling restriction area. Before filling the erased area, the filling restriction area is first determined, and the filling restriction area is excluded to ensure that the scenes within the filling restriction area are not used to fill the erased area.

This step is used to analyze the image to be filled after obtaining the image to be filled, and determine the filling restriction area. In some embodiments, the step of determining the filling restriction area in the image to be filled can be described as follows: analyzing the image to be filled, performing feature recognition by detecting and segmenting the image to be filled, identifying and detecting key scenes and salient scenes in the image to be filled, and designating areas in which the detected key scenes and salient scenes are located as the filling restriction area.

For example, the analysis identifies which feature types of scene content is contained in the image to be filled. For the feature types, a feature type priority table may be pre-constructed, indicating which type of feature has the highest priority and which has the lowest priority, with feature priorities of various types ranked. Features in the image to be filled that have relatively high priorities are used as key and salient features, and an area in the image where these types of feature scenes are located is used as the filling restriction area.

Intelligent analysis is performed on the image to be filled to analyze the type of the image to be filled, such as whether it is a portrait, a landscape photograph, etc. Buildings present in a landscape photograph can be understood as salient and key content. Salient and key content refers to content obtained through feature recognition that is indivisible as a whole, such as a person, an animal, or a building. A person, an animal, a building, and other indivisible elements are identified and segmented, and their corresponding scene area is called the filling restriction area.

S103: Determine a filling search area based on the filling restriction area, and fill the erased area to obtain a target image.

In some embodiments, after the filling restriction area is determined in the above step, the filling search area may be further determined based on the filling restriction area and the erased area. It can be learned that a scene corresponding to the filling restriction area is a key and salient scene. After the filling restriction area is excluded, a scene corresponding to the background area in the image may be used to fill an area to be filled. After the filling restriction area and the erased area in the original image are excluded, the filling search area may be determined based on another area. For example, a remaining area in the original image excluding the filling restriction area and the erased area may be used as the filling search area. Considering that a feature of a scene corresponding to an area relatively far from the area to be filled may differ greatly from a feature of a scene near the area to be filled, it is also possible to limit the remaining area in the original image excluding the filling restriction area and the erased area, and a part of the remaining area is used as the filling search area.

In some embodiments, the erased area is used as the area to be filled, and the erased area is filled based on some scenes in the filling search area. First, each pixel within the erased area is used as a center, the erased area is divided into different area blocks based on a particular size, and an area block in which an edge of the erased area is located is determined. It can be understood that the area block in which the edge of the erased area is located contains some colors. To ensure that a style obtained after the erased area is filled is relatively natural and realistic, a color of a scene used for filling needs to be close to the color contained in the area block in which the edge is located. By calculating a color similarity between an area in which the edge is located and an area to be searched, a scene corresponding to an area block with the highest similarity is used as a filling basis, and a corresponding area block within the area in which the edge is located is filled based on pixel values of pixels of the scene. The process is equivalent to a search process of the best matching block, that is, finding, in a known area, an area block that is most similar to a block to be filled, for example, calculating an RGB mean squared error to obtain an area block with the shortest distance as an area block most similar to the block to be filled. After the area block most similar to the block to be filled is determined, the block to be filled is filled based on a pixel value of the most similar area block.

It should be learned that the area in which the edge of the erased area is located includes a plurality of area blocks. A color-related matching degree between each area block and the filling search area needs to be calculated, to separately determine a matched area block corresponding to each area block, and an area block in which a corresponding edge is located is separately filled based on pixel values of pixels within the matched area block. For each area block within the area in which the edge of the erased area is located, the above steps are performed in parallel.

It should be learned that color similarity matching can be performed only when a block includes a part of colors. Therefore, a process of filling the erased area can be understood as iterative filling from the outside to the inside. First, color filling is performed on an outmost area block of the erased area, and then an erased area obtained after filling is used as a new erased area. For an outmost area block of the new erased area, a matched area block is searched, and color filling is performed on a new outmost area block, and so on, until the erased area in the image to be filled is completely filled. In this case, a filled image may be used as the target image.

According to the image processing method provided in this embodiment of the present disclosure, the image to be filled with the erased area is first obtained in response to the erasing operation on the original image. Then, the filling restriction area is determined based on the image to be filled. Finally, the filling search area is determined based on the filling restriction area, and the erased area is filled to obtain the target image. Different from the related art in which other image content in the image is used for filling the erased area, in the above technical solution, the filling restriction area is first determined before the erased area is filled; an area presenting key scene content in the image is used as the filling restriction area; and image content in the original image excluding the erased area and the filling restriction area is used as a source of a filling scene that may be used. This avoids using the scene in the filling restriction area to fill the erased area, thereby ensuring that the filled image is more realistic and natural. In addition, the filling restriction area is excluded when the filling search area is determined. In comparison with traversing the entire image to search for a filling scene with the highest similarity, a calculation amount during the search for the filling scene is reduced, and image processing efficiency is improved.

In some embodiments, the determining a filling restriction area based on the image to be filled includes the following steps: a1)-c1).

a1) Perform feature recognition on the image to be filled.

In some embodiments, the image to be filled is detected and segmented to obtain various types of scene content in the image to be filled. A method used for feature recognition is not specifically limited in this embodiment. For example, a pre-trained neural network model may be used as a feature recognition model, and the image to be filled is input into the feature recognition model to obtain the various types of scene content contained in the image to be filled as a feature recognition result.

b1) Determine, based on the recognition result, key scene content contained in the image to be filled.

The recognition result refers to various types of scene content contained in an object to be filled. In this embodiment, feature priorities may be preset for various types of scenes, and a feature with a relatively high priority is used as the key scene content. The step of determining, based on the recognition result, key scene content contained in the image to be filled may include: determining a feature type of scene content in the image to be filled from the recognition result; and determining scene content with a feature type matching a set feature type as the key scene content.

For example, assuming that for a person image, priorities are set in order. A priority of a person is higher than that of an article, which is higher than that of the background. In this case, when a specific person image contains a person, an article, sky, and ground, the person is used as the key scene content.

c1) Determine a scene area presenting the key scene content as the filling restriction area.

Specifically, the scene area presenting the key scene content is used as the filling restriction area.

The above embodiment refines the process of determining the filling restriction area, by identifying the image to be filled to determine the key scene content contained in the area to be filled, and designating the scene area of the key scene content as the filling restriction area. This can ensure that the filling restriction area is excluded when determining the filling search area, so as to avoid the use of scene content in the filling restriction area to fill the image to be filled, thereby ensuring that the filled image maintains consistency in the style, and is realistic, and natural.

In some embodiments, the determining a filling search area based on the filling restriction area, and filling the erased area to obtain a target image includes the following steps: a2)-d2).

a2) Determine other scene areas than the filling restriction area and the erased area as the filling search area.

The filling restriction area is determined in the above step. It is further necessary to determine the filling search area based on the filling restriction area. The erased area is filled based on the filling search area. The remaining area in the original image excluding the filling restriction area and the erased area may be used as the filling search area. Alternatively, considering that an area excessively far from the erased area in the image to be filled has a low scene similarity, there is no need to excessively expand a search range. Therefore, an area is further defined from the other scene areas as the filling search area of the image to be filled.

b2) Construct, for pixels within the erased area, area blocks centered on the pixels, and determine a filtered non-completely blank area block as a block to be filled.

It can be understood that the erased area includes a plurality of pixels, and it may be considered that this step is performed in parallel on each pixel within the erased area. For the pixel within the erased area, an area block of a set size is constructed with each pixel as a center. The set size may be set based on a historical empirical value. For each pixel within the erased area, a plurality of area blocks are constructed. An area block in which an edge of the erased area is located is a non-completely blank area block, and an inner area block within the erased area may be a completely-blank area block. In this embodiment, the non-completely blank area block is first filtered from the plurality of constructed area blocks, and the filtered non-completely blank area block is used as the block to be filled. This is equivalent to using the area block in which the edge of the erased area is located as the block to be filled, and the area block is first filled during subsequent filling.

c2) Determine a filling matching block for the block to be filled from the filling search area, and fill the block to be filled based on the filling matching block to obtain a filled intermediate image.

This step is equivalent to searching for the best matching block from the filling search area, that is, finding, in a known filling search area, an area block that is most similar to the block to be filled. Herein, the similarity may be determined based on the shortest distance, namely, a minimum RGB colors mean squared error.

For each block to be filled, an area block matching the block to be filled is determined from the filling search area as the filling matching block. The filling matching block can be understood as an area block that is most similar to the block to be filled. For each block to be filled, a corresponding filling matching block should be determined. The block to be filled is filled based on pixel values of pixels within the filling matching block. When filling a block to be filled, it may be considered that the filling is performed in parallel on a plurality of blocks to be filled. After the block to be filled is filled based on the filling matching block, the filled image may be obtained, which is designated as the intermediate image in this embodiment.

d2) Return to reperform the operation of determining the filling search area, in response to detecting that some of the erased area still exists in the intermediate image; otherwise, determine the intermediate image as the target image, in response to detecting that there is no erased area in the intermediate image.

In some embodiments, the intermediate image is obtained after the periphery of the erased area is filled, and it is detected whether the erased area still exists in the intermediate image. If the erased area still exists in the intermediate image, it is necessary to return to reperform the operation of determining the filling search area, for iterative execution. With iterative execution of the above operation, the erased area becomes increasingly small. The above iterative operation is terminated when there is no erased area in the intermediate image. A finally obtained image is used as the target image. If there is no erased area in the intermediate image, the intermediate image is used as the target image. The above embodiment embodies the step of determining the filling search area based on the filling restriction area and the step of filling the erased area to obtain the target image. The filling restriction area is excluded when the filling search area is determined. This avoids using the scene in the filling restriction area to fill the erased area, thereby ensuring that the filled image is more realistic and natural. In addition, the filling restriction area is excluded when the filling search area is determined. In comparison with traversing the entire image to search for a filling scene with the highest similarity, a calculation amount during the search for the filling scene is reduced. Further, the process of filling the erased area can be understood as iterative filling from the outside to the inside. This ensures a natural transition of the filling scene and makes the filled image more realistic.

On the basis of the above embodiment, the above image processing method may alternatively be further optimized. Specifically, the determining other scene areas than the filling restriction area and the erased area as the filling search area includes the following steps: a21)-a22).

a21) Obtain an edge trajectory constituting the erased area, and determine distance values from pixels within the other scene areas to the edge trajectory.

Considering that a calculation amount is relatively large when searching for the filling matching block is performed by using the entire other scene areas as the filling search area, the filling search area is limited to a range smaller than the entire other scene areas in this embodiment. Specifically, the edge trajectory constituting the erased area is obtained, and the edge trajectory may be represented by coordinate information in the image. Similarly, coordinate information of pixels within the other scene areas may also be learned. Based on the coordinate information of the edge trajectory and the coordinate information of the pixels within the other scene areas, the distance values corresponding to the pixels within the other scene areas from the edge trajectory may be calculated.

a22) Construct the filling search area based on pixels with distance values less than a set distance threshold.

The set distance threshold may be determined based on a historical empirical value. Specifically, an area consisting of the pixels with distance values being less than the set distance threshold is used as the filling search area. It can be understood that as a blank part of the erased area decreases, a range of the filling search area may be accordingly reduced.

In the above technical solution, the filling search area is optimized, and the range smaller than the entire other scene areas is determined as the filling search area. In an underlying implementation, compared with traversing the entire image to search for an area block with the highest similarity, randomly searching for the filling matching block based on a local area reduces a calculation amount.

On the basis of the above embodiment, the above image processing method may alternatively be further optimized. In some embodiments, the determining a filling matching block for the block to be filled from the filling search area includes: c21-c24.

c21) Obtain neighboring area blocks with an offset step size of a set value from the block to be filled.

The offset step size of the block to be filled can be understood as a translation step size when the block to be filled is translated upward, downward, leftward, or rightward. There may be one or more neighboring area blocks. For example, the set value of the offset step size is a value of one pixel or a value of five pixels. Specifically, an area block obtained by offsetting the block to be filled by a set step size is obtained and designated as the neighboring area block.

c22) Randomly determine an initial matching block for the block to be filled from the filling search area, and designate a matching block randomly determined for each neighboring area block as a propagation block.

After the neighboring area blocks are determined, a matching block is separately determined for the block to be filled and for the neighboring area blocks. The matching block for the block to be filled may be designated as the initial matching block, and the matching block for the neighboring area block may be designated as the propagation block.

In this embodiment, a randomized algorithm is used to randomly initialize a position of the matching block for the block to be filled, and the matching block is designated as the initial matching block. For the matching block randomly determined for each neighboring area block, the matching block for the neighboring area block is designated as the propagation block.

c23) Determine area blocks with an offset step size of the set value from the propagation block as candidate matching blocks for the block to be filled.

In this step, after the propagation block is determined, area blocks are expanded around the propagation block as the candidate matching blocks for the block to be filled. Due to a local correlation of the image, the best matching block corresponding to a specific local area block may also be within a same local area, that is, values of offset step sizes in a specific local area may be the same. Specifically, the area blocks with the offset step size of the set value from the propagation block are determined as the candidate matching blocks for the block to be filled.

c24) Determine the filling matching block for the block to be filled based on the initial matching block and the candidate matching blocks.

Specifically, after the initial matching block and the candidate matching blocks are obtained, the filling matching block for the block to be filled is further determined.

The above technical solution embodies the process of determining the filling matching block for the block to be filled from the filling search area. Through initialization, propagation, and a local search, searching for the best matching block is implemented, and the filling matching block for the block to be filled is determined. In comparison with traversing the entire image to search for an area block with the highest similarity, in the above technical solution, searching for the filling matching block is limited to a relatively small area, reducing a calculation amount during searching.

In some embodiments, the determining the filling matching block for the block to be filled based on the initial matching block and the candidate matching blocks includes: c241)-c243).

c241) Separately determine a matching similarity between the block to be filled and the initial matching block, as well as a matching similarity between the block to be filled and the candidate matching blocks.

In this embodiment, the filling matching block for the block to be filled is determined based on a local search. Through propagation in the above step, it is possible that the best matching area block has not yet been found. In this case, the search area may be further limited, and a random search is performed in a small surrounding range, to find a filling area block best matched.

Specifically, the matching similarity between the block to be filled and each of the initial matching block and the candidate matching blocks is separately calculated. Calculating the matching similarity can be understood as calculating pixel values of pixels in the initial matching block and the candidate matching blocks pixel values of a non-blank area in the block to be filled, for example, calculating a variance of the pixel values as a determining indicator of the matching similarity.

c242) Determine a matching block with the highest matching similarity as a local matching reference block, and construct a local matching area centered on the local matching reference block.

Specifically, the matching block with the highest matching similarity is determined as the local matching reference block. Considering the local correlation of the image, the best matching block corresponding to a specific local area block may also be within a same local area. Therefore, centered on the local matching reference block, an area is constructed with a particular size and is designated as the local matching area. The local matching area is used as an area for searching for the filling matching block.

c243) Determine a matching block, within the local matching area, with the highest matching similarity to the block to be filled as the filling matching block for the block to be filled.

Specifically, a matching similarity between an area block within the local matching area and the block to be filled is separately calculated, and the matching block with the highest matching similarity is determined as the filling matching block for the block to be filled.

The above technical solution embodies the step of determining the filling matching block for the block to be filled based on the initial matching block and the candidate matching blocks. Fully considering the local correlation of the image, the best matching block corresponding to a specific local area block may also be within a same local area, and a search range is limited to a relatively small area, reducing a calculation amount of searching, and improving image processing efficiency.

On the basis of the above embodiment, the above image processing method may alternatively be further optimized. In some embodiments, the filling the block to be filled based on the filling matching block includes the following steps: e1)-e4).

e1) For a pixel contained in the block to be filled, use a pixel value in the filling matching block that corresponds to the pixel as a filling pixel value, in response to the pixel being not contained in other block(s) to be filled.

In this step, the block to be filled is formed with a certain pixel as its center, and one pixel does not necessarily fall within one block to be filled, and may fall within many blocks to be filled. A determination is performed for the pixel contained in the block to be filled to determine whether the pixel still exists in other blocks to be filled. The pixel contained in the block to be filled may or may not be contained in other blocks to be filled. If the pixel is not in other blocks to be filled, only a pixel value (of a pixel that corresponds to this pixel) in the filling matching block that corresponds to the pixel needs to be used as the filling pixel value. For example, when determining which blocks to be filled the pixel is contained, the determination can be performed based on coordinate information of the pixel and vertex coordinate information of the blocks to be filled. If the range determined based on vertex coordinate information of a block to be filled contains the coordinate information of the pixel, it is determined that the pixel is contained in that block to be filled.

e2) If the pixel is contained in the other blocks to be filled, determine the other blocks to be filled containing the pixels, and obtain other filling matching blocks corresponding to the other blocks to be filled.

This step is for a case that the pixel contained in the blocks to be filled is contained in the other blocks to be filled. If the pixel is contained in the other blocks to be filled, it is necessary to first determine which blocks to be filled contain the pixel and determine filling matching blocks respectively corresponding to the blocks to be filled containing the pixel.

e3) Determine a filling pixel value for the pixel based on pixel values corresponding to the pixel within the filling matching block and the other filling matching blocks.

To prevent colors of blocks in the block to be filled from being excessively fragmented, in this step, the pixel values corresponding to the pixel within the filling matching block and the other filling matching blocks are comprehensively considered, and the filling pixel value for the pixel is determined based on the pixel values corresponding to the pixel within these filling matching blocks. This processing manner can achieve a smoothing effect. For example, the filling pixel value for the pixel may be determined by calculating an average value of the pixel values of the pixel within the filling matching block and the other filling matching blocks. Calculating the average value of the pixel values is equivalent to a smoothing processing manner. For example, the pixel contained in the block to be filled exists in ten matching blocks. In this case, the ten matching blocks and pixel values in the ten matching blocks are determined respectively. The ten pixel values are then averaged to obtain an average value as the filling pixel value for the pixel. Certainly, the pixel may exist in a completely-blank area block. In this case, the completely-blank area block is ignored and only the block to be filled is considered.

e4) Use the filling pixel value to perform color filling on the block to be filled.

Specifically, the filling pixel value used to perform color filling on the block to be filled, that is, a pixel value for the pixel within the block to be filled is set to the filling pixel value.

In the above technical solution, the implementation step of filling the block to be filled based on the filling matching block is further detailed, and the filling pixel value for the pixel is determined separately for the cases that the pixel of the block to be filled exists in the other blocks to be filled or do not exist in the other blocks to be filled. For the pixel contained in the other blocks to be filled, the pixel values in the filling matching block and the other filling matching blocks are averaged to implement smoothing processing, so that the color transition between the blocks in the block to be filled is natural and smooth without fragmentation, making the target image obtained after filling more realistic and natural.

For example, FIG. 1d presents a diagram of displaying an effect of a target image during execution of an image processing method according to an embodiment. In comparison with the filled image in FIG. 1c obtained through processing by using the related art, which contains mismatched scenes such as shoes and clothes, as shown in FIG. 1d, according to the image processing method provided in this embodiment, the filled image is obtained. In an image area naturally filled, image content presented by the erased area 12 of the image appears to match a style of a surrounding image, making the target image more realistic and natural.

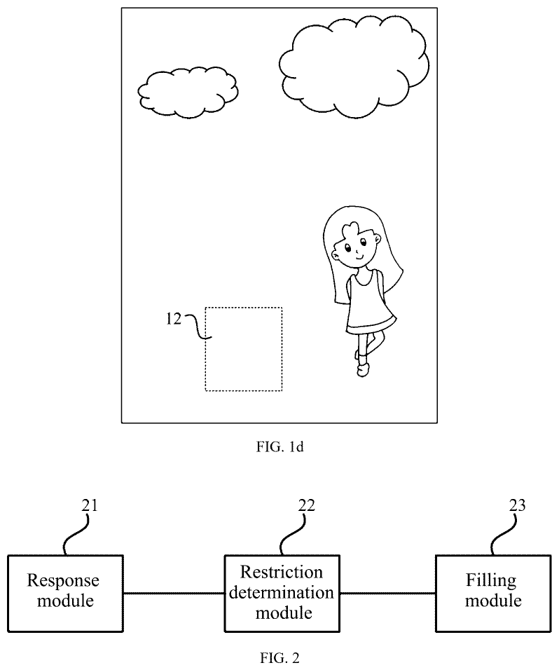

FIG. 2 presents a schematic diagram of a structure of an image processing apparatus according to an embodiment of the present disclosure. As shown in FIG. 2, the apparatus includes: a response module 21, a restriction determination module 22, and a filling module 23.

The response module 21 is configured to obtain, in response to an erasing operation on an original image, an image to be filled with an erased area.

The restriction determination module 22 is configured to determine a filling restriction area based on the image to be filled.

The filling module 23 is configured to determine a filling search area based on the filling restriction area, and fill the erased area to obtain a target image.

The image processing apparatus is provided in this embodiment of the present disclosure. Different from the related art in which other image content in the image is used for filling the erased area, in the above technical solution, the filling restriction area is first determined before the erased area is filled; an area presenting key scene content in the image is used as the filling restriction area; and image content in the original image excluding the erased area and the filling restriction area is used as a source of a filling scene that may be used. This avoids using a scene in the filling restriction area to fill the erased area, thereby ensuring that a filled image is more realistic and natural. In addition, the filling restriction area is excluded when the filling search area is determined. In comparison with traversing the entire image to search for a filling scene with the highest similarity, a calculation amount during the search for the filling scene is reduced, and image processing efficiency is improved.

In some embodiments, the restriction determination module 22 may be specifically configured to:
perform feature recognition on the image to be filled;
determine, based on a recognition result, key scene content contained in the image to be filled; and
determine a scene area presenting the key scene content as the filling restriction area.

In some embodiments, the filling module 23 may include:
a search area determination unit configured to determine other scene areas than the filling restriction area and the erased area as the filling search area;
a filling block determination unit configured to construct, for pixels within the erased area, area blocks centered on the pixels, and determine a filtered non-completely blank area block as a block to be filled;
an intermediate image determination unit configured to determine a filling matching block for the block to be filled from the filling search area, and fill the block to be filled based on the filling matching block to obtain a filled intermediate image; and
a recurrence unit configured to: return to reperform the operation of determining the filling search area, in response to detecting that an erased area still exists in the intermediate image; otherwise, determine the intermediate image as the target image.

In some embodiments, the search area determination unit may be specifically configured to:
obtain an edge trajectory constituting the erased area, and determine distance values from pixels within the other scene areas to the edge trajectory; and
construct the filling search area based on pixels with distance values less than a set distance threshold.

In some embodiments, the intermediate image determination unit may be specifically configured to:
obtain neighboring area blocks with an offset step size of a set value from the block to be filled;
randomly determine an initial matching block for the block to be filled from the filling search area, and designate a matching block randomly determined for each neighboring area block as a propagation block;
determine area blocks with an offset step size of the set value from the propagation block as candidate matching blocks of the block to be filled; and
determine the filling matching block for the block to be filled based on the initial matching block and the candidate matching blocks.

In some embodiments, the steps that the intermediate image determination unit is configured to determine the filling matching block for the block to be filled based on the initial matching block and the candidate matching blocks may specifically include:
separately determining a matching similarity between the block to be filled and the initial matching block, as well as a matching similarity between the block to be filled and the candidate matching blocks;
determining a matching block with the highest matching similarity as a local matching reference block, and constructing a local matching area centered on the local matching reference block; and
determining a matching block within the local matching area with the highest matching similarity to the block to be filled as the filling matching block for the block to be filled.

In some embodiments, the intermediate image determination use, for a pixel in the block to be filled, a pixel value in the filling matching block that corresponds to the pixel as a filling pixel value, in response to the pixel being not in other block(s) to be filled,
determine the other blocks to be filled containing the pixels, and obtain other filling matching blocks corresponding to the other blocks to be filled;
determine a filling pixel value for the pixel based on pixel values corresponding to the pixel within the filling matching block and the other filling matching blocks; and
use the filling pixel value to perform color filling on the block to be filled.

The image processing apparatus provided in this embodiment of the present disclosure can perform the image processing method provided in any embodiment of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the scope of protection of the embodiments of the present disclosure.

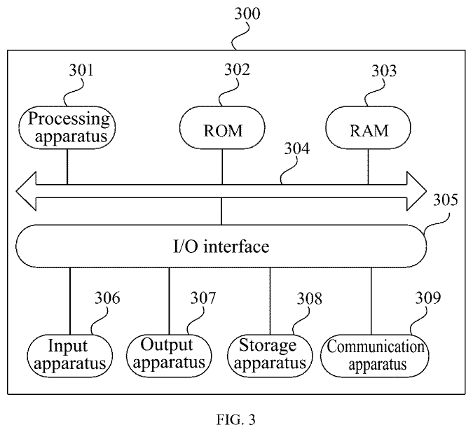

FIG. 3 presents a schematic diagram of a structure of an electronic device according to an embodiment of the present disclosure. Reference is made to FIG. 3 below, which is a schematic diagram of a structure of an electronic device (such as a terminal device or a server in FIG. 3) 300 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable media player (PMP), and a vehicle-mounted terminal (e.g., a vehicle navigation terminal), and fixed terminals such as a digital TV and a desktop computer. The electronic device shown in FIG. 3 is merely an example, and shall not impose any limitation on the function and scope of use of the embodiments of the present disclosure.

As shown in FIG. 3, the electronic device 300 may include a processing apparatus (for example, a central processing unit or a graphics processing unit) 301 that may perform a variety of appropriate actions and processing in accordance with a program stored in a read-only memory (ROM) 302 or a program loaded from a storage apparatus 308 into a random access memory (RAM) 303. The RAM 303 further stores various programs and data required for the operation of the electronic device 300. The processing apparatus 301, the ROM 302, and the RAM 303 are connected to one another through a bus 304. An input/output (I/O) interface 305 is also connected to the bus 304.

Generally, the following apparatuses may be connected to the I/O interface 305: an input apparatus 306 including, for example, a touchscreen, a touchpad, a keyboard, a mouse, a camera, a microphone, an accelerometer, and a gyroscope; an output apparatus 307 including, for example, a liquid crystal display (LCD), a speaker, and a vibrator; the storage apparatus 308 including, for example, a tape and a hard disk; and a communication apparatus 309. The communication apparatus 309 may allow the electronic device 300 to perform wireless or wired communication with other devices to exchange data. Although FIG. 3 shows the electronic device 300 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 309, installed from the storage apparatus 308, or installed from the ROM 302. When the computer program is executed by the processing apparatus 301, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to this embodiment of the present disclosure and the image processing methods according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium having stored thereon a computer program that, when executed by a processor, causes the image processing method provided in the above embodiments to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: perform image processing method according to some embodiments of the present disclosure.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The present disclosure further provides a computer program product, including instructions that, when executed by a processor, cause the processor to implement the image processing method according to any one of the above embodiments.

The present disclosure further provides a computer program, including instructions that, when executed by a processor, cause the processor to implement the image processing method according to any one of the above embodiments.

According to one or more embodiments of the present disclosure, [Example 1] provides an image processing method, and the method includes:
obtaining, in response to an erasing operation on an original image, an image to be filled with an erased area;
determining a filling restriction area based on the image to be filled; and
determining a filling search area based on the filling restriction area, and filling the erased area to obtain a target image.

According to one or more embodiments of the present disclosure, [Example 2] provides an image processing method, and the method may further include:
Optionally, the step of determining a filling restriction area based on the image to be filled includes: performing feature recognition on the image to be filled;
determining, based on a recognition result, key scene content contained in the image to be filled; and
determining a scene area presenting the key scene content as the filling restriction area.

According to one or more embodiments of the present disclosure, [Example 3] provides an image processing method, and the method may further include:
Optionally, the step of determining a filling search area based on the filling restriction area, and filling the erased area to obtain a target image may include:
determining other scene areas than the filling restriction area and the erased area as the filling search area;
constructing, for pixels within the erased area, area blocks centered on the pixels, and determining a filtered non-completely blank area block as a block to be filled;
determining a filling matching block for the block to be filled from the filling search area, and filling the block to be filled based on the filling matching block to obtain a filled intermediate image; and
returning to reperform the operation of determining the filling search area, in response to detecting that some of the erased area still exists in the intermediate image; otherwise, determining the intermediate image as the target image.

According to one or more embodiments of the present disclosure, [Example 4] provides an image processing method, and the method may further include:
Optionally, the determining other scene areas than the filling restriction area and the erased area as the filling search area may include:
obtaining an edge trajectory constituting the erased area, and determining distance values from pixels within the other scene areas to the edge trajectory; and
constructing the filling search area based on pixels with distance values less than a set distance threshold.

According to one or more embodiments of the present disclosure, [Example 5] provides an image processing method, and the method includes:
Optionally, the step of determining a filling matching block for the block to be filled from the filling search area includes:
obtaining neighboring area blocks with an offset step size of a set value from the block to be filled;
randomly determining an initial matching block for the block to be filled from the filling search area, and designating a matching block randomly determined for each neighboring area block as a propagation block;
determining area blocks with an offset step size of the set value from the propagation block as candidate matching blocks of the block to be filled; and
determining the filling matching block for the block to be filled based on the initial matching block and the candidate matching blocks.

According to one or more embodiments of the present disclosure, [Example 6] provides an image processing method, and the method may further include:
The step of determining the filling matching block for the block to be filled based on the initial matching block and the candidate matching blocks includes:
separately determining a matching similarity between the block to be filled and the initial matching block, as well as a matching similarity between the block to be filled and the candidate matching blocks;
determining a matching block with the highest matching similarity as a local matching reference block, and constructing a local matching area centered on the local matching reference block; and
determining a matching block within the local matching area with the highest matching similarity to the block to be filled as the filling matching block for the block to be filled.

According to one or more embodiments of the present disclosure, [Example 7] provides an image processing method, and the method may further include:
Optionally, the step of filling the block to be filled based on the filling matching block includes:
using, for a pixel in the block to be filled, a pixel value in the filling matching block that corresponds to the pixel as a filling pixel value, in response to the pixel being not in other block(s) to be filled; otherwise,
determining the other blocks to be filled containing the pixels, and obtaining other filling matching blocks corresponding to the other blocks to be filled;
determining a filling pixel value for the pixel based on pixel values corresponding to the pixel within the filling matching block and the other filling matching blocks; and
using the filling pixel value to perform color filling on the block to be filled.

According to one or more embodiments of the present disclosure, [Example 8] provides an image processing apparatus, and the apparatus includes:
a response module configured to obtain, in response to an erasing operation on an original image, an image to be filled with an erased area;
a restriction determination module configured to determine a filling restriction area based on the image to be filled; and
a filling module configured to determine a filling search area based on the filling restriction area, and fill the erased area to obtain a target image.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under particular circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An image processing method, comprising:
obtaining, in response to an erasing operation on an original image, an image to be filled with an erased area;
determining a filling restriction area based on the image to be filled; and
determining a filling search area based on the filling restriction area, and filling the erased area to obtain a target image.

2. The image processing method according to claim 1, wherein the determining a filling restriction area based on the image to be filled comprises:
performing feature recognition on the image to be filled;
determining, based on a recognition result, key scene content in the image to be filled; and
determining a scene area presenting the key scene content as the filling restriction area.

3. The image processing method according to claim 1, wherein the determining a filling search area based on the filling restriction area, and filling the erased area to obtain a target image comprises:
determining other scene area(s) than the filling restriction area and the erased area as the filling search area;
constructing, for pixels within the erased area, area blocks centered on the pixels, and determining a filtered non-completely blank area block as a block to be filled;
determining a filling matching block for the block to be filled from the filling search area, and filling the block to be filled based on the filling matching block to obtain a filled intermediate image; and
returning to reperform the operation of determining the filling search area, in response to detecting that some of the erased area still exists in the intermediate image; otherwise, determining the intermediate image as the target image, in response to detecting that there is no erased area in the intermediate image.

4. The image processing method according to claim 3, wherein the determining other scene area(s) than the filling restriction area and the erased area as the filling search area comprises:
obtaining an edge trajectory constituting the erased area, and determining distance values from pixels within the other scene area(s) to the edge trajectory; and
constructing the filling search area based on pixels with distance values less than a set distance threshold.

5. The image processing method according to claim 3, wherein the determining a filling matching block for the block to be filled from the filling search area comprises:
obtaining neighboring area blocks with an offset step size of a set value from the block to be filled;
randomly determining an initial matching block for the block to be filled from the filling search area, and designating a matching block randomly determined for each neighboring area block as a propagation block;
determining area blocks with an offset step size of the set value from the propagation block as candidate matching blocks of the block to be filled; and
determining the filling matching block for the block to be filled based on the initial matching block and the candidate matching blocks.

6. The image processing method according to claim 5, wherein the determining the filling matching block for the block to be filled based on the initial matching block and the candidate matching blocks comprises:
separately determining a matching similarity between the block to be filled and the initial matching block, as well as a matching similarity between the block to be filled and the candidate matching blocks;
determining the initial matching block or the candidate matching block with the highest matching similarity as a local matching reference block, and constructing a local matching area centered on the local matching reference block; and
determining a matching block within the local matching area with the highest matching similarity to the block to be filled as the filling matching block for the block to be filled.

7. The image processing method according to claim 3, wherein the filling the block to be filled based on the filling matching block comprises:
using, for a pixel in the block to be filled, a pixel value in the filling matching block that corresponds to the pixel as a filling pixel value, in response to the pixel being not in other block(s) to be filled; and
using the filling pixel value to perform color filling on the block to be filled.

8. The image processing method according to claim 3, wherein the filling the block to be filled based on the filling matching block comprises:
determining the other block(s) to be filled containing the pixel, and obtaining other filling matching block(s) corresponding to the other block(s) to be filled, in response to the pixel net contained in other block(s) to be filled;
determining a filling pixel value for the pixel based on pixel values corresponding to the pixel within the filling matching block and the other filling matching block(s); and
using the filling pixel value to perform color filling on the block to be filled.

9. The image processing method according to claim 3, wherein the constructing, for pixels within the erased area, area blocks centered on the pixels comprises:
constructing, for the pixels within the erased area, the area blocks centered on the pixels, in an order from an edge to a center within the erased area.

10. (canceled)

11. An electronic device, comprising:
one or more processors; and
a storage apparatus configured to store one or more programs, wherein
the one or more programs, when executed by the one or more processors, cause the one or more processors to implement the image processing method, comprising:
obtaining, in response to an erasing operation on an original image, an image to be filled with an erased area;
determining a filling restriction area based on the image to be filled; and
determining a filling search area based on the filling restriction area, and filling the erased area to obtain a target image.

12. A non-transitory computer-readable storage medium having a computer program stored thereon, wherein the program, when executed by a processor, causes the image processing method to be implemented, wherein the image processing method comprises:
obtaining, in response to an erasing operation on an original image, an image to be filled with an erased area;
determining a filling restriction area based on the image to be filled; and
determining a filling search area based on the filling restriction area, and filling the erased area to obtain a target image.

13-14. (canceled)

15. The electronic device according to claim 11, wherein the determining a filling restriction area based on the image to be filled comprises:
performing feature recognition on the image to be filled;
determining, based on a recognition result, key scene content in the image to be filled; and
determining a scene area presenting the key scene content as the filling restriction area.

16. The electronic device according to claim 11, wherein the determining a filling search area based on the filling restriction area, and filling the erased area to obtain a target image comprises:
determining other scene area(s) than the filling restriction area and the erased area as the filling search area;
constructing, for pixels within the erased area, area blocks centered on the pixels, and determining a filtered non-completely blank area block as a block to be filled;
determining a filling matching block for the block to be filled from the filling search area, and filling the block to be filled based on the filling matching block to obtain a filled intermediate image; and
returning to reperform the operation of determining the filling search area, in response to detecting that some of the erased area still exists in the intermediate image; otherwise, determining the intermediate image as the target image, in response to detecting that there is no erased area in the intermediate image.

17. The electronic device according to claim 16, wherein the determining other scene area(s) than the filling restriction area and the erased area as the filling search area comprises:
obtaining an edge trajectory constituting the erased area, and determining distance values from pixels within the other scene area(s) to the edge trajectory; and
constructing the filling search area based on pixels with distance values less than a set distance threshold.

18. The electronic device according to claim 16, wherein the determining a filling matching block for the block to be filled from the filling search area comprises:
obtaining neighboring area blocks with an offset step size of a set value from the block to be filled;
randomly determining an initial matching block for the block to be filled from the filling search area, and designating a matching block randomly determined for each neighboring area block as a propagation block;
determining area blocks with an offset step size of the set value from the propagation block as candidate matching blocks of the block to be filled; and
determining the filling matching block for the block to be filled based on the initial matching block and the candidate matching blocks.

19. The image processing method according to claim 18, wherein the determining the filling matching block for the block to be filled based on the initial matching block and the candidate matching blocks comprises:
separately determining a matching similarity between the block to be filled and the initial matching block, as well as a matching similarity between the block to be filled and the candidate matching blocks;
determining the initial matching block or the candidate matching block with the highest matching similarity as a local matching reference block, and constructing a local matching area centered on the local matching reference block; and
determining a matching block within the local matching area with the highest matching similarity to the block to be filled as the filling matching block for the block to be filled.

20. The non-transitory computer-readable storage medium according to claim 12, wherein the determining a filling restriction area based on the image to be filled comprises:
performing feature recognition on the image to be filled;
determining, based on a recognition result, key scene content in the image to be filled; and
determining a scene area presenting the key scene content as the filling restriction area.

21. The non-transitory computer-readable storage medium according to claim 12, wherein the determining a filling search area based on the filling restriction area, and filling the erased area to obtain a target image comprises:
determining other scene area(s) than the filling restriction area and the erased area as the filling search area;
constructing, for pixels within the erased area, area blocks centered on the pixels, and determining a filtered non-completely blank area block as a block to be filled;
determining a filling matching block for the block to be filled from the filling search area, and filling the block to be filled based on the filling matching block to obtain a filled intermediate image; and
returning to reperform the operation of determining the filling search area, in response to detecting that some of the erased area still exists in the intermediate image; otherwise, determining the intermediate image as the target image, in response to detecting that there is no erased area in the intermediate image.

22. The non-transitory computer-readable storage medium according to claim 21, wherein the determining other scene area(s) than the filling restriction area and the erased area as the filling search area comprises:
obtaining an edge trajectory constituting the erased area, and determining distance values from pixels within the other scene area(s) to the edge trajectory; and
constructing the filling search area based on pixels with distance values less than a set distance threshold.

23. The non-transitory computer-readable storage medium according to claim 21, wherein the determining a filling matching block for the block to be filled from the filling search area comprises:
obtaining neighboring area blocks with an offset step size of a set value from the block to be filled;
randomly determining an initial matching block for the block to be filled from the filling search area, and designating a matching block randomly determined for each neighboring area block as a propagation block;
determining area blocks with an offset step size of the set value from the propagation block as candidate matching blocks of the block to be filled; and
determining the filling matching block for the block to be filled based on the initial matching block and the candidate matching blocks.
